(19) United States
(12) Patent Application Publication
(10) Pub. No.: US 2025/0203293 A1
(43) Pub. Date: Jun. 19, 2025

(54) PLANAR VOICE COIL, PLANAR VOICE COIL SUBSTRATE, AND MANUFACTURING METHOD FOR PLANAR VOICE COIL SUBSTRATE

(71) Applicant: Phoenix Pioneer Technology Co., Ltd., Hsinchu County (TW)

(72) Inventors: PAO-HUNG CHOU, Hsinchu County (TW); MING-YEH CHANG, Hsinchu County (TW); CHE-WEI HSU, Hsinchu County (TW); SHIH-PING HSU, Hsinchu County (TW)

(21) Appl. No.: 18/964,256

(22) Filed: Nov. 29, 2024

(30) Foreign Application Priority Data
Dec. 19, 2023 (TW) 112149507

(51) Int. Cl. H04R 9/02; H04R 9/04

(52) U.S. Cl. CPC H04R 9/025; H04R 9/047; H04R 2209/024; H04R 2209/041

(57) ABSTRACT

The present invention discloses a planar voice coil substrate, including a dielectric layer and a first patterned conductive layer, a first magnetic metal, a second patterned conductive layer, and a second magnetic metal that are embedded in the dielectric layer. The first patterned conductive layer has a first helical coil structure, and the first magnetic metal is configured in the first helical coil structure. The second patterned conductive layer has a second helical coil structure disposed opposite the first helical coil structure, and the second magnetic metal is configured in the second helical coil structure. The first helical coil structure and the second helical coil structure form an electrical loop via conductive elements. Additionally, the present invention also discloses a planar voice coil applied to the planar voice coil substrate and a manufacturing method for planar voice coil substrate.

### CROSS-REFERENCE TO RELATED APPLICATION

This application claims the priority benefit of Taiwan application (No. 112149507), filed on Dec. 19, 2023. The entirety of the above-mentioned patent application is hereby incorporated by reference herein and made a part of this specification.

### FIELD OF THE INVENTION

The present invention relates to a semiconductor device substrate and a manufacturing method thereof, particularly to a planar voice coil, a planar voice coil substrate, and a manufacturing method for planar voice coil substrate.

### BACKGROUND OF THE INVENTION

The voice coil (voice coil) is primarily an electronic component applied to the microphone and speaker, and can provide an action force through a magnetic field to cause the diaphragm to vibrate and produce a sound.

Referring to FIG. 1, an existing voice coil structure 10 includes a frame 11, a magnet 12, a coil 13, and a diaphragm 14. The magnet 12 and the coil 13 are disposed in an accommodation space via an opening of the frame 11. The diaphragm 14 is disposed on an outer side of the opening of the frame 11. The coil 13 is wound around the magnet 12. After power is supplied to the coil 13, an interaction between an energized conductor and the magnetic field generates an action force F01, and the magnitude of the action force depends on the strength of the magnetic field.

As for the existing voice coil structure 10, winding the coil around the magnet 12 achieves sufficient magnetic field strength and action force, but physical limitation on this winding structure makes it difficult to reduce the overall size and is unfavorable for automatic assembly. Therefore, how to resolve the above problems of the prior art is one of the current important subjects.

### SUMMARY OF THE INVENTION

Given the above description, an objective of the present invention is to provide a planar voice coil, a planar voice coil substrate, and a manufacturing method for planar voice coil substrate, so as to obtain a planar coil substrate with fine-pitch coils and good flatness through a semiconductor packaging substrate process.

To achieve the above objective, the planar voice coil substrate of the present invention includes a dielectric layer, and a first patterned conductive layer, a first magnetic metal, a second patterned conductive layer, a second magnetic metal, a first conductor, and a second conductor that are embedded in the dielectric layer. The dielectric layer has a first surface and a second surface that are opposite each other. The first patterned conductive layer has a first helical coil structure embedded on a side of the first surface of the dielectric layer, where two ends of the first helical coil structure have a first endpoint and a second endpoint. The first magnetic metal is embedded in the dielectric layer, located on a same level as the first patterned conductive layer, and configured in the first helical coil structure. The second patterned conductive layer has a second helical coil structure embedded on a side of a second surface of the dielectric layer, where two ends of the second helical coil structure have a third endpoint and a fourth endpoint, and a fifth endpoint is configured on a side of the second helical coil structure and opposite the first endpoint. The second magnetic metal is embedded in the dielectric layer, located on a same level as the second patterned conductive layer, and configured in the second helical coil structure of the second patterned conductive layer. The first conductor is connected between the first endpoint and the fifth endpoint. The second conductor is connected between the second endpoint and the third endpoint. The fourth endpoint and the fifth endpoint are both connected to an externally-and-electrically connected pad exposed from the second surface of the dielectric layer.

In an embodiment, the first magnetic metal and the second magnetic metal are connected as a whole via a third magnetic metal.

In an embodiment, the first magnetic metal and/or the second magnetic metal is made of nickel, iron-nickel alloy, or iron-cobalt-nickel alloy.

Additionally, to achieve the above objective, the planar voice coil of the present invention includes a frame, a diaphragm, a first planar voice coil substrate, and a magnetic element. The frame has a sidewall and a base, where the sidewall and the base form an opening and an accommodation space. The diaphragm is disposed at the opening and covers the accommodation space. The first planar voice coil substrate is disposed on a side of the diaphragm opposite the accommodation space and integrally connected to the diaphragm, and has the component composition and connection relationship of the planar voice coil substrate as described above. The magnetic element is arranged opposite the planar voice coil substrate and in the accommodation space and that is connected to the base.

In an embodiment, the magnetic element is a second planar voice coil substrate, which is arranged opposite the planar voice coil substrate connected onto the diaphragm and in the accommodation space, and connected to the base. Additionally, the second planar voice coil substrate also includes the component composition and connection relationship of the planar voice coil substrate as described above.

Furthermore, to achieve the foregoing objective, the manufacturing method for planar voice coil substrate of the present invention includes the following steps: providing a carrier board; forming a first dielectric layer on the carrier board; forming a first patterned conductive layer on the first dielectric layer, where the first patterned conductive layer has a first helical coil structure, and two ends of the first helical coil structure have a first endpoint and a second endpoint; forming a first magnetic metal on the first dielectric layer, where the first magnetic metal is configured in the first helical coil structure; forming a second dielectric layer that covers the first patterned conductive layer and the first magnetic metal; in the second dielectric layer, forming a first conductor connected to the first endpoint and forming a second conductor connected to the second endpoint; forming a second patterned conductive layer on the second dielectric layer, where the second patterned conductive layer has a second helical coil structure, two ends of the second helical coil structure have a third endpoint and a fourth endpoint, the third endpoint is connected to the second conductor, and a fifth endpoint is configured on a side of the second helical coil structure and connected to the first conductor; forming a second magnetic metal on the second dielectric layer, where the second magnetic metal is configured in the second helical coil structure; forming a third dielectric layer that covers the second patterned conductive layer and the second magnetic metal; in the third dielectric layer, forming an externally-and-electrically connected pad connected to both the fourth endpoint and the fifth endpoint, where the externally-and-electrically connected pad is exposed from the third dielectric layer; and removing the carrier board to form a planar voice coil substrate.

In an embodiment, the first patterned conductive layer or the second patterned conductive layer is formed through photolithography etching and electroplating. The first magnetic metal or the second magnetic metal is formed through photolithography etching and electroplating or sputtering.

In an embodiment, after the second dielectric layer is formed, the method further includes: forming a third magnetic metal in the second dielectric layer, where the third magnetic metal is stacked on the first magnetic metal; and when the second magnetic metal is formed on the second dielectric layer, stacking the second magnetic metal on the third magnetic metal. The first magnetic metal, the second magnetic metal, and the third magnetic metal are combined into one.

In summary, according to the planar voice coil, the planar voice coil substrate, and the manufacturing method for planar voice coil substrate of the present invention, a semiconductor manufacturing process is used to manufacture the planar voice coil substrate, so as to replace the voice coil formed by directly winding a coil on the magnet in the prior art, increasing the magnetic flux via the planar voice coil substrate, thereby reducing the size and weight of the planar voice coil.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic cross-sectional view of an existing voice coil structure;

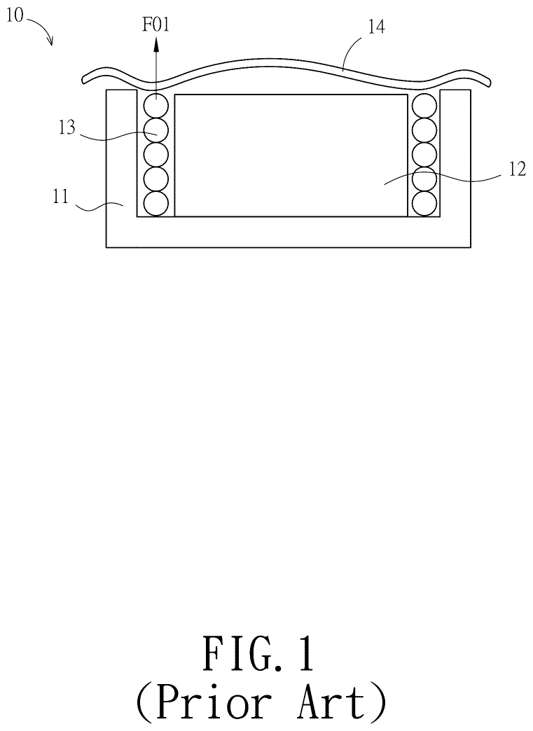

FIG. 2 is a schematic cross-sectional view of a planar voice coil according to a first embodiment of the present invention;

FIG. 3A is a schematic diagram of a relative positional relationship between the first patterned conductive layer and a first magnetic metal from a first perspective;

FIG. 3B is a schematic diagram of a relative positional relationship between a second patterned conductive layer and a second magnetic metal from the first perspective;

FIG. 4A is a schematic cross-sectional view taken along line B-B in FIG. 3A and FIG. 3B;

FIG. 4B is a schematic cross-sectional view taken along line C-C in FIG. 3A and FIG. 3B;

FIG. 5 is a schematic cross-sectional view of a first planar voice coil substrate according to another preferred embodiment;

FIG. 6 is a schematic cross-sectional view of the planar voice coil according to a second embodiment of the present invention;

FIG. 7 is a schematic cross-sectional view of the planar voice coil according to a third embodiment of the present invention; and

FIGS. 8A to 8J are schematic structural diagrams of a manufacturing method for planar voice coil substrate according to preferred embodiments of the present invention.

### DETAILED DESCRIPTION OF PREFERRED EMBODIMENTS

To enable those skilled in the art to understand the content of the present invention and to implement the content of the present invention accordingly, the following provides description with reference to the preferred embodiments and the accompanying drawings.

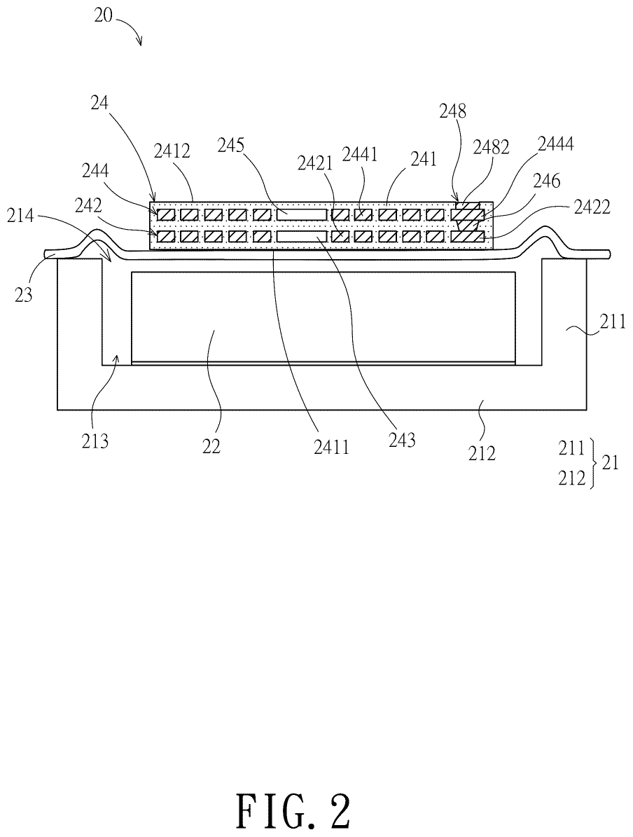

FIG. 2 is a schematic cross-sectional view of a planar voice coil 20 according to a preferred embodiment of the present invention. The planar voice coil 20 includes a frame 21, a magnetic element 22, a diaphragm 23, and a first planar voice coil substrate 24. The planar voice coil 20 can be used in electronic apparatuses such as microphones or speakers.

The frame 21 has a sidewall 211 and a base 212, where the sidewall 211 stands and extends at the periphery of the base 212 in a direction away from the base 212. In this embodiment, the sidewall 211 and the base 212 form a 90 degree angle. The base 212 may be approximately circular, oval, rectangular, or of any other possible geometric shape. The sidewall 211 and the base 212 form an accommodation space 213 and an opening 214.

The magnetic element 22 is, for example, a magnet, located in the accommodation space 213, and fixed to the base 212 of the frame 21. In an embodiment, the accommodation space 213 may be designed to be equivalent to the size of the magnetic element 22, allowing the magnetic element 22 to be securely fixed in the accommodation space 213. In an embodiment, the magnetic element 22 may be fixed to the base 212 or the sidewall 211 by means of locking, clamping, bonding, or the like.

The diaphragm 23 is connected to the periphery of the opening 214 to cover the accommodation space 213, so the magnetic element 22 is located between the diaphragm 23 and the frame 21.

The first planar voice coil substrate 24 is disposed on the side of the diaphragm 23 opposite the accommodation space 213. In this embodiment, the first planar voice coil substrate 24 is bonded to the diaphragm 23 by means of an adhesive element, such as adhesive or double-sided adhesive, so that the diaphragm 23 and the first flat voice coil substrate 24 are bonded to each other to form a single unit. In short, the first planar voice coil substrate 24 and the magnetic element 22 are respectively disposed on two opposite sides of the diaphragm 23.

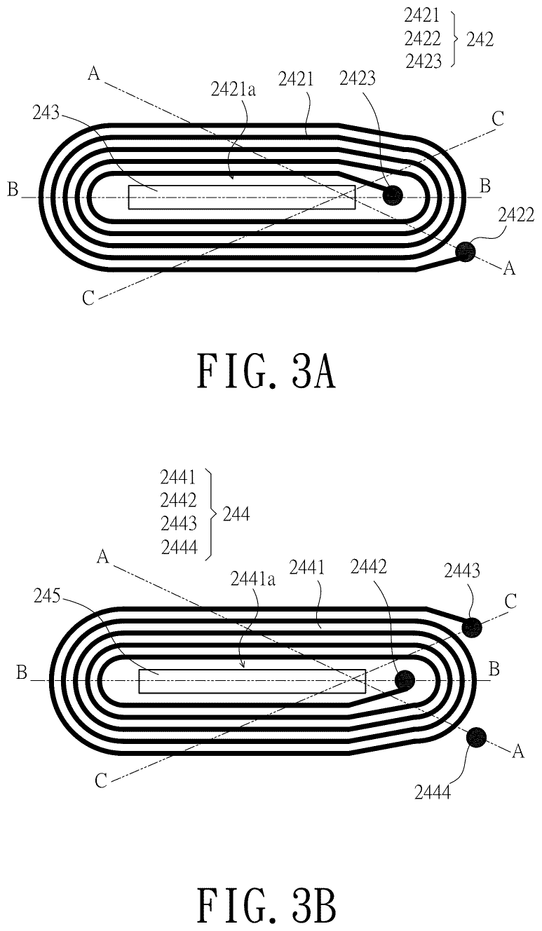

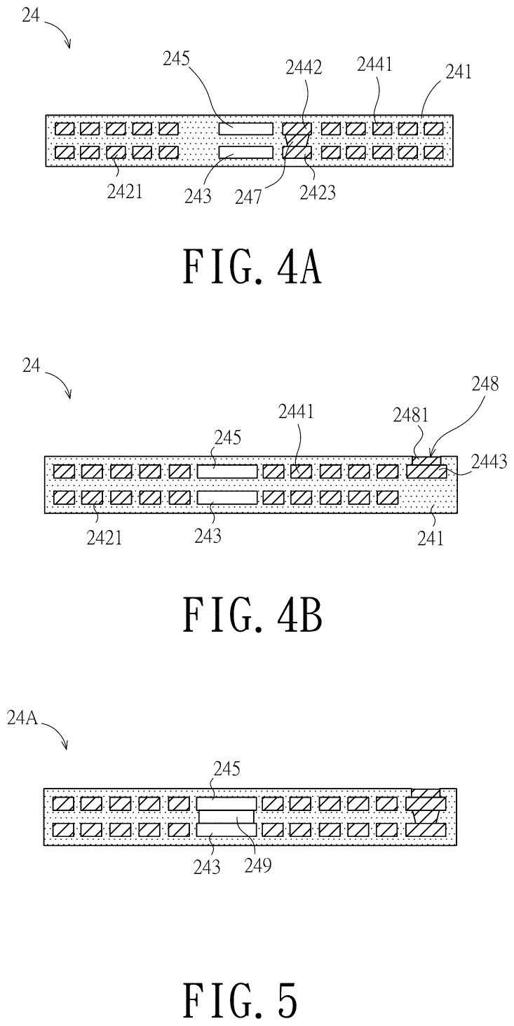

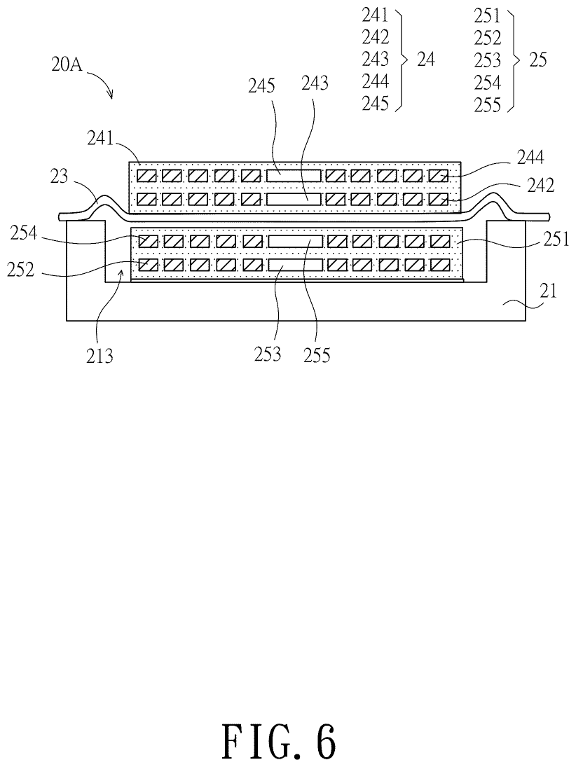

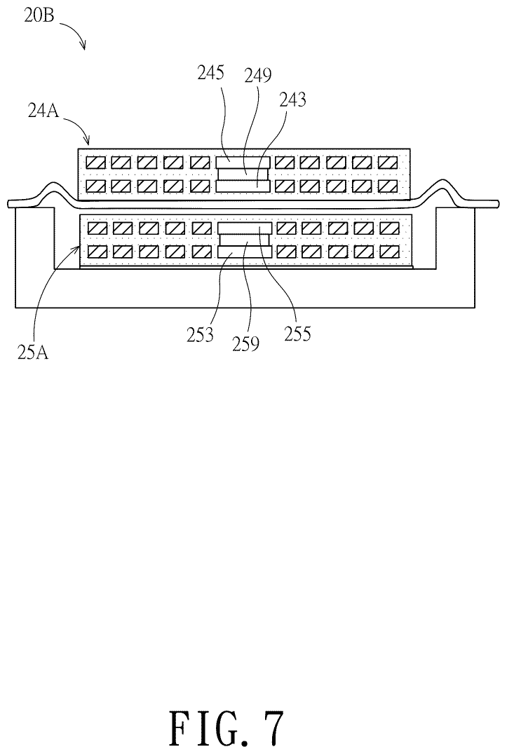

To further describe the first planar voice coil substrate 24 in detail, refer to FIG. 2, FIG. 3A, FIG. 3B, FIG. 4A, and FIG. 4B together. The first planar voice coil substrate 24 shown in FIG. 2 is a cross-sectional view taken along the line A-A in FIGS. 3A and 3B. Additionally, to clarify the correspondences of elements of the first planar voice coil substrate 24, FIG. 4A is a schematic cross-sectional view taken along the line B-B in FIGS. 3A and 3B, and FIG. 4B is a schematic cross-sectional view taken along the line C-C in FIGS. 3A and 3B.

The first planar voice coil substrate 24 is a substrate manufactured through a semiconductor manufacturing process. The first planar voice coil substrate 24 includes a dielectric layer 241, a first patterned conductive layer 242, a first magnetic metal 243, a second patterned conductive layer 244, a second magnetic metal 245, a first conductor 246, a second conductor 247, and an externally-and-electrically connected pad layer 248.

The dielectric layer 241 has a first surface 2411 and a second surface 2412 that are opposite each other, and its material includes but is not limited to an Epoxy material, an FR5 material, a BT material, an ABF (Ajinomoto Build-up film), a solid-state molding material (Epoxy Molding Compound, EMC), or PI.

The first patterned conductive layer 242, the first magnetic metal 243, the second patterned conductive layer 244, the second magnetic metal 245, the first conductor 246, the second conductor 247, and the externally-and-electrically connected pad layer 248 are all embedded in the dielectric layer 241. The materials of the first patterned conductive layer 242, the second patterned conductive layer 244, the first conductor 246, the second conductor 247, and the externally-and-electrically connected pad layer 248 include but are not limited to copper. The materials of the first magnetic metal 243 and the second magnetic metal 245 include but are not limited to nickel, iron-nickel alloy, or iron-cobalt-nickel alloy.

In the dielectric layer 241, the first patterned conductive layer 242 and the second patterned conductive layer 244 are opposite and located on different levels. Furthermore, the first patterned conductive layer 242 and the first magnetic metal 243 are located on the same level and on a side adjacent to the first surface 2411 of the dielectric layer 241, that is, a side close to the diaphragm 23. Additionally, the second patterned conductive layer 244 and the second magnetic metal 245 are located on the same level and on a side adjacent to the second surface 2412 of the dielectric layer 241, that is, a side away from the diaphragm 23.

FIG. 3A and FIG. 3B are schematic diagrams of the first planar voice coil substrate 24 observed from a first perspective (top view in this embodiment), where FIG. 3A is a schematic diagram of a relative positional relationship between the first patterned conductive layer 242 and the first magnetic metal 243, and FIG. 3B is a schematic diagram of a relative positional relationship between the second patterned conductive layer 244 and the second magnetic metal 245.

As shown in FIG. 3A, the first patterned conductive layer 242 has a first helical coil structure 2421, and two ends of the first helical coil structure 2421 respectively have a first endpoint 2422 and a second endpoint 2423. The first magnetic metal 243 is located at a first central part 2421a of the first helical coil structure 2421, that is, at the center of the first helical coil structure 2421.

As shown in FIG. 3B, the second patterned conductive layer 244 has a second helical coil structure 2441, and two ends of the second helical coil structure 2441 respectively have a third endpoint 2442 and a fourth endpoint 2443. The second magnetic metal 245 is located at a second central part 2441a of the second helical coil structure 2441, that is, at the center of the second helical coil structure 2441. Additionally, the second patterned conductive layer 244 has a fifth endpoint 2444 that is arranged on a side of the second helical coil structure 2441 and opposite to the first endpoint 2422.

Referring to FIG. 2 and FIG. 4A together, the first endpoint 2422 and the fifth endpoint 2444 are electrically connected to each other via the first conductor 246, and the second endpoint 2423 and the third endpoint 2442 are electrically connected to each other via the second conductor 247. Referring to FIG. 2 and FIG. 4B together, the externally-and-electrically connected pad layer 248 has a first externally-and-electrically connected pad 2481 and a second externally-and-electrically connected pad 2482. The first externally-and-electrically connected pad 2481 is disposed on and electrically connected to the fourth endpoint 2443, with an upper surface of the first externally-and-electrically connected pad 2481 exposed from the second surface 2412 of the dielectric layer 241. The second externally-and-electrically connected pad 2482 is disposed on and electrically connected to the fifth endpoint 2444, with an upper surface of the second externally-and-electrically connected pad 2482 exposed from the second surface 2412 of the dielectric layer 241.

Referring to FIG. 2 again, the polarity of the side of the first magnetic metal 243 close to the diaphragm 23 is the same as the polarity of the side of the magnetic element 22 close to the diaphragm 23. In this embodiment, N pole is used as an example. Additionally, the polarity of the side of the second magnetic metal 245 away from the diaphragm 23 is opposite to the polarity of the side of the first magnetic metal 243 close to the diaphragm 23, meaning that the polarity of the side of the second magnetic metal 245 away from the diaphragm 23 is S pole.

In the present invention, the first patterned conductive layer 242 and the second patterned conductive layer 244 are used to form coils, which generate a magnetic field after power is applied and subsequently creates a repulsive phenomenon with the N pole or S pole of the magnetic element 22, causing the diaphragm 23 to vibrate and produce audio. As the input voltage is controlled to adjust the magnetic field strength, the force exerted on the diaphragm 23 can be changed, thereby controlling the frequency amplitude of the sound.

Additionally, placing the first magnetic metal 243 and the second magnetic metal 245 with high magnetic permeability therein can increase the magnetic flux of the planar voice coil 20. This can reduce the number of coils to achieve the same inductance value. In other words, the number of layers, volume, and weight of the patterned conductive layers can all be reduced, achieving a light and thin effect.

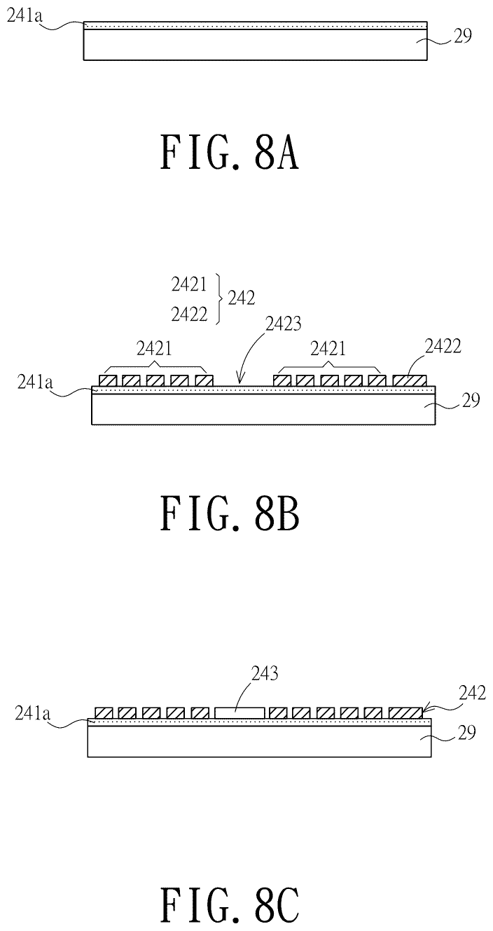

FIG. 5 shows a first planar voice coil substrate 24A according to another preferred embodiment. In this embodiment, the first planar voice coil substrate 24A further includes a third magnetic metal 249, which is connected between the first magnetic metal 243 and the second magnetic metal 245. In other embodiments, the first magnetic metal 243, the second magnetic metal 245, and the third magnetic metal 249 may also be components that are integrally formed.

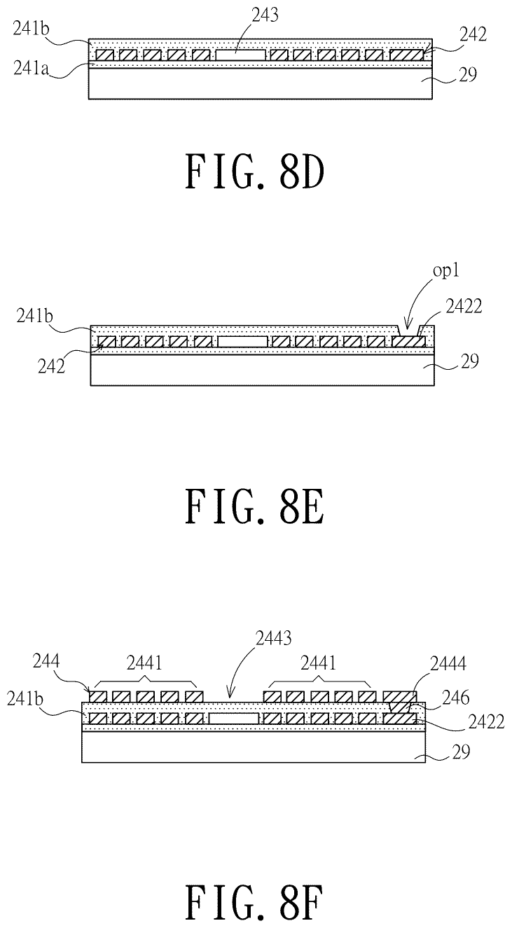

Then, referring to FIG. 6, the magnetic element 22 in the planar voice coil 20 may further be replaced with the second planar voice coil substrate 25 to form a planar voice coil 20A. The second planar voice coil substrate 25 is located in the accommodation space 213 and fixed to the base 212 of the frame 21. In this embodiment, an adhesive element (not shown in the figure) is used to bond the second planar voice coil substrate 25 to the base 212.

The second planar voice coil substrate 25 includes a dielectric layer 251, a first patterned conductive layer 252, a first magnetic metal 253, a second patterned conductive layer 254, a second magnetic metal 255, a first conductor 256, a second conductor 257, and an externally-and-electrically connected pad layer 258. The structure of the second planar voice coil substrate 25 may be the same as that of the first planar voice coil substrate 24, which is not elaborated herein.

It should be particularly noted that in the second planar voice coil substrate 25, the polarity of the side of the second magnetic metal 255 close to the diaphragm 23 is the same as the polarity of the side of the first magnetic metal 243 of the first planar voice coil substrate 24 close to the diaphragm 23, using N poles as an example in this embodiment. Additionally, in this embodiment, currents in opposite directions are input to the first planar voice coil substrate 24 and the second planar voice coil substrate 25 to generate magnetic fields with different polarities, and based on the characteristics of attraction or repulsion, the diaphragm 23 can vibrate and produce audio.

Additionally, it should be also noted that the first planar voice coil substrate 24 and the second planar voice coil substrate 25 are exemplified with only two layers of patterned conductive layers. In other embodiments, more layers of patterned conductive layers can be designed as needed, which is not limited thereto.

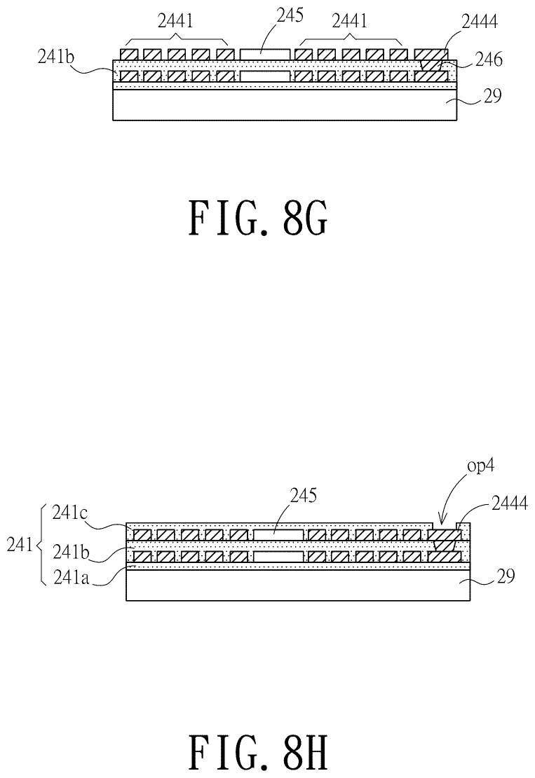

Furthermore, referring to FIG. 7, the first planar voice coil substrate 24 and the second planar voice coil substrate 25 in FIG. 6 may further be replaced with the first planar voice coil substrate 24A in FIG. 5. As shown in FIG. 7, the first planar voice coil substrate 24A of the planar voice coil 20B has the first magnetic metal 243, the third magnetic metal 249, and the second magnetic metal 245 that are interconnected. The second planar voice coil substrate 25A of the planar voice coil 20B has the first magnetic metal 253, the third magnetic metal 259, and the second magnetic metal 255 that are interconnected.

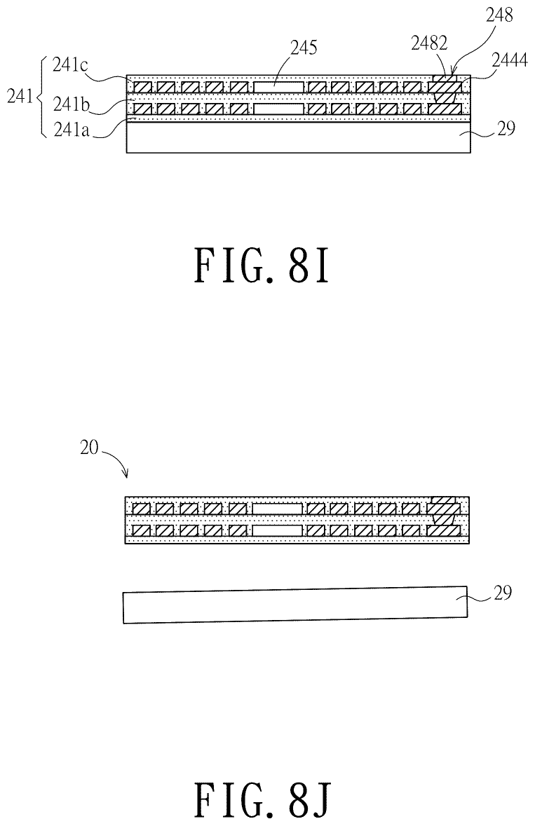

Then, use the first planar voice coil substrate 20 as an example and refer to FIGS. 8A to 8J to describe the manufacturing method for planar voice coil substrate of the present invention. The manufacturing method including the following steps. It should be noted that some components are referenced in conjunction with the aforementioned drawings due to a perspective issue.

As shown in FIG. 8A, step S01: Provide a carrier board 29. Step S02: Form a first dielectric layer 241a on the carrier board 29. The first dielectric layer 241a may be formed on the carrier board 29 through lamination.

As shown in FIG. 8B, step S03: Form a first patterned conductive layer 242 on the first dielectric layer 241a. The first patterned conductive layer 242 has a first helical coil structure 2421, and two ends of the first helical coil structure 2421 have a first endpoint 2422 and a second endpoint 2423. In this embodiment, the first patterned conductive layer 242 is formed through photolithography etching and copper electroplating.

Referring to FIGS. 8B and 8C, step S04: Form a first magnetic metal 243 on the first dielectric layer 241a. The first magnetic metal 243 may be formed through electroplating or sputtering process at the position of the first central part 2421a of the first patterned conductive layer 242.

As shown in FIG. 8D, step S05: Form a second dielectric layer 241b that covers the first patterned conductive layer 242 and the first magnetic metal 243. The second dielectric layer 241b is formed through lamination.

As shown in FIG. 8E, step S06: Form a first opening op1 and a second opening (not shown) in the second dielectric layer 241b. The first opening op1 corresponds to the first endpoint 2422 of the first patterned conductive layer 242, while the second opening corresponds to the second endpoint 2423. The first opening op1 and the second opening may be formed through laser drilling or etching technique.

As shown in FIG. 8F, step S07: Form a first conductor 246 in the first opening op1 to be connected to the first endpoint 2422, and form a second conductor in the second opening to be connected to the second endpoint 2423. The first conductor 246 and the second conductor are formed through photolithography and copper electroplating. Then, step S08: Form a second patterned conductive layer 244 on the second dielectric layer 241b. The second patterned conductive layer 244 has a second helical coil structure 2441, and two ends of the second helical coil structure 2441 have a third endpoint 2442 and a fourth endpoint 2443. The third endpoint 2442 is connected to the second conductor 247. Additionally, the second patterned conductive layer 244 also has a fifth endpoint 2444 configured on a side of the second helical coil structure 2441 and connected to the first conductor 246. In this embodiment, the second patterned conductive layer 244 is formed through photolithography and copper electroplating. It is worth mentioning that in different embodiments, step S07 and step S08 can be completed simultaneously in a process step, which is not limited thereto.

Referring to FIGS. 8F and 8G, step S09: Form a second magnetic metal 245 on the second dielectric layer 241b. In this embodiment, the second magnetic metal 245 may be formed at the position of the second central part 2441a of the second helical coil structure 2441 through electroplating or sputtering process.

As shown in FIG. 8H, step S10: Form a third dielectric layer 241c through lamination to cover the second patterned conductive layer 244 and the second magnetic metal 245. Step S11: Form a third opening and a fourth opening op4 on the third dielectric layer 241c. The third opening corresponds to the fourth endpoint 2443, and the fourth opening op4 corresponds to the fifth endpoint 2444. The third opening and the fourth opening op4 may be formed through laser drilling or etching technique.

As shown in FIG. 8I, step S12: Form an externally-and-electrically connected pad layer 248 in the third opening and the fourth opening op4. In this embodiment, the externally-and-electrically connected pad layer 248 has a first externally-and-electrically connected pad 2481 and a second externally-and-electrically connected pad 2482. The first externally-and-electrically connected pad 2481 is connected to the fourth endpoint 2443, and the second externally-and-electrically connected pad 2482 is connected to the fifth endpoint 2444. Additionally, the first externally-and-electrically connected pad 2481 and the second externally-and-electrically connected pad 2482 are exposed from the upper surface of the third dielectric layer 241c. The first dielectric layer 241a, the second dielectric layer 241b, and the third dielectric layer 241c form the dielectric layer 241. Finally, as shown in FIG. 8J, step S13: Remove the carrier board 29 to form the planar voice coil substrate 20.

It is worth mentioning that in other embodiments, after the second dielectric layer is formed in step S05, an opening may be formed at the position corresponding to the first magnetic metal, and a third magnetic metal may be formed therein and stacked on the first magnetic metal, to form the foregoing planar voice coil substrate having the first magnetic metal, the second magnetic metal, and the third magnetic metal.

In summary, according to the planar voice coil, the planar voice coil substrate, and the manufacturing method thereof of the present invention, the semiconductor manufacturing process is used to manufacture the planar voice coil substrate and a magnetic metal with a high magnetic permeability is placed therein, showing the following effects:
(1) Placing the magnetic metal at the central part of the helical coil structure of the patterned conductive layer can increase the magnetic flux of the planar voice coil, thereby reducing the number of coils. This significantly helps to reduce the volume and weight of the planar voice coil, achieving a light and thin effect.
(2) Using the semiconductor process allows the patterned conductive layer to have features: a fine pitch and good flatness, and the planar voice coil substrate to have highly stable resistance and inductance performance.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A planar voice coil substrate, comprising:
a dielectric layer, having a first surface and a second surface opposite each other;
a first patterned conductive layer, having a first helical coil structure embedded on a side of the dielectric layer adjacent to the first surface, wherein two ends of the first helical coil structure respectively have a first endpoint and a second endpoint;
a first magnetic metal, embedded in the dielectric layer, located on a same level as the first patterned conductive layer, and arranged in the first helical coil structure;
a second patterned conductive layer, having a second helical coil structure embedded on a side of the dielectric layer adjacent to the second surface, wherein two ends of the second helical coil structure respectively have a third endpoint and a fourth endpoint, and a fifth endpoint is arranged on a side of the second helical coil structure and opposite the first endpoint;
a second magnetic metal, embedded in the dielectric layer, located on a same level as the second patterned conductive layer, and arranged in the second helical coil structure of the second patterned conductive layer;
a first conductor, connected between the first endpoint and the fifth endpoint; and
a second conductor, connected between the second endpoint and the third endpoint;
wherein the fourth endpoint and the fifth endpoint each are connected to an externally-and-electrically-connected pad exposed from the second surface of the dielectric layer.

2. The planar voice coil substrate according to claim 1, wherein the first magnetic metal and the second magnetic metal are connected as a whole via a third magnetic metal.

3. The planar voice coil substrate according to claim 1, wherein a material of the first magnetic metal and/or the second magnetic metal is nickel, an iron-nickel alloy, or an iron-cobalt-nickel alloy.

4. A planar voice coil, comprising:
a frame, having a sidewall and a base, wherein the sidewall and the base form an opening and an accommodation space;
a diaphragm, disposed in the opening and covering the accommodation space;
a first planar voice coil substrate, arranged on a side of the diaphragm relative to the accommodation space and combined with each other in a single continuous unit, and
a magnetic element, arranged opposite to the first planar voice coil substrate in the accommodation space and connected to the base;
wherein the first planar voice coil substrate comprising:
a dielectric layer, having a first surface and a second surface opposite each other;
a first patterned conductive layer, having a first helical coil structure embedded on a side of the dielectric layer adjacent to the first surface, wherein two ends of the first helical coil structure respectively have a first endpoint and a second endpoint;
a first magnetic metal, embedded in the dielectric layer, located on a same level as the first patterned conductive layer, and arranged in the first helical coil structure;
a second patterned conductive layer, having a second helical coil structure embedded on a side of the dielectric layer adjacent to the second surface, wherein two ends of the second helical coil structure respectively have a third endpoint and a fourth endpoint, and a fifth endpoint is arranged on a side of the second helical coil structure and opposite the first endpoint;
a second magnetic metal, embedded in the dielectric layer, located on a same level as the second patterned conductive layer, and arranged in the second helical coil structure of the second patterned conductive layer;
a first conductor, connected between the first endpoint and the fifth endpoint; and
a second conductor, connected between the second endpoint and the third endpoint;
wherein the fourth endpoint and the fifth endpoint each are connected to an externally-and-electrically-connected pad exposed from the second surface of the dielectric layer.

5. The planar voice coil according to claim 4, wherein the first magnetic metal and the second magnetic metal are connected as a whole via a third magnetic metal.

6. The planar voice coil according to claim 4, wherein the magnetic element is a second planar voice coil substrate, and the second planar voice coil substrate comprising:
a dielectric layer, having a first surface and a second surface opposite each other;
a first patterned conductive layer, having a first helical coil structure embedded on a side of the dielectric layer adjacent to the first surface, wherein two ends of the first helical coil structure respectively have a first endpoint and a second endpoint;
a first magnetic metal, embedded in the dielectric layer, located on a same level as the first patterned conductive layer, and arranged in the first helical coil structure;
a second patterned conductive layer, having a second helical coil structure embedded on a side of the dielectric layer adjacent to the second surface, wherein two ends of the second helical coil structure respectively have a third endpoint and a fourth endpoint, and a fifth endpoint is arranged on a side of the second helical coil structure and opposite the first endpoint;
a second magnetic metal, embedded in the dielectric layer, located on a same level as the second patterned conductive layer, and arranged in the second helical coil structure of the second patterned conductive layer;
a first conductor, connected between the first endpoint and the fifth endpoint; and
a second conductor, connected between the second endpoint and the third endpoint;
wherein the fourth endpoint and the fifth endpoint each are connected to an externally-and-electrically-connected pad exposed from the second surface of the dielectric layer.

7. The planar voice coil according to claim 6, wherein the first magnetic metal and the second magnetic metal are connected as a whole via a third magnetic metal.

8. A manufacturing method for a planar voice coil substrate, the manufacturing method comprising:
providing a carrier board;
forming a first dielectric layer on the carrier board;
forming a first patterned conductive layer on the first dielectric layer, wherein the first patterned conductive layer has a first helical coil structure, and two ends of the first helical coil structure respectively have a first endpoint and a second endpoint;
forming a first magnetic metal on the first dielectric layer, wherein the first magnetic metal is arranged in the first helical coil structure;
forming a second dielectric layer to cover the first patterned conductive layer and the first magnetic metal;
forming a first conductor connected to the first endpoint and forming a second conductor connected to the second endpoint in the second dielectric layer;
forming a second patterned conductive layer on the second dielectric layer, wherein the second patterned conductive layer has a second helical coil structure, two ends of the second helical coil structure respectively have a third endpoint and a fourth endpoint, the third endpoint is connected to the second conductor, and a fifth endpoint is arranged on a side of the second helical coil structure and connected to the first conductor;
forming a second magnetic metal on the second dielectric layer, wherein the second magnetic metal is arranged in the second helical coil structure;
forming a third dielectric layer to cover the second patterned conductive layer and the second magnetic metal;
forming, at the third dielectric layer, an externally-and-electrically connected pad connected to the fourth endpoint and the fifth endpoint, wherein the externally-and-electrically connected pad is exposed from the third dielectric layer; and
removing the carrier board.

9. The manufacturing method for a planar voice coil substrate according to claim 8, wherein the first patterned conductive layer or the second patterned conductive layer is formed through photolithography etching and electroplating.

10. The manufacturing method for a planar voice coil substrate according to claim 8, wherein the first magnetic metal or the second magnetic metal is formed through photolithography etching and electroplating or sputtering.

11. The manufacturing method for planar voice coil substrate according to claim 8, wherein after the second dielectric layer is formed, the further manufacturing method comprises:
forming a third magnetic metal in the second dielectric layer, wherein the third magnetic metal is stacked on the first magnetic metal, and the third magnetic metal and the first magnetic metal are connected as a whole; and
stacking the second magnetic metal on the third magnetic metal when the second magnetic metal is formed on the second dielectric layer, wherein the second magnetic metal and the third magnetic metal are connected as a whole.
